(19) United States
(12) Patent Application Publication
(10) Pub. No.: US 2019/0385090 A1
(43) Pub. Date: Dec. 19, 2019

(54) SYSTEMS AND METHODS FOR USING ARTIFICIAL INTELLIGENCE MODELS TO IDENTIFY A CURRENT THREAT SCENARIO

(71) Applicant: Honeywell International Inc., Morristown, NJ (US)

(72) Inventors: Atul Laxman Katole, Bangalore (IN); lshit Trivedi, Bangalore (IN); Sunil Venugopalan, Bangalore (IN); Jagadeesh Brahmajosyula, Bangalore (IN)

(21) Appl. No.: 16/008,248

(22) Filed: Jun. 14, 2018

(51) Int. Cl. G06N 99/00; G06N 5/04

(52) U.S. Cl. CPC G06N 99/005; G06N 5/04

(57) ABSTRACT

Systems and methods for using artificial intelligence models to identify a current threat scenario are provided that train the artificial intelligence models to infer or recognize different threat scenarios using values from a plurality of sensors, including historical data from the plurality of sensors during known threat scenarios. In some embodiments, systems and methods can use current ones of the values from the plurality of sensors to aggregate a respective output from each one of a set of the plurality of artificial intelligence models to identify the current threat scenario present in an area monitored by the plurality of sensors and execute an action corresponding to the current threat scenario.

### FIELD

The present invention relates generally to artificial intelligence. More particularly, the present invention relates to systems and methods for using artificial intelligence models to identify a current threat scenario.

### BACKGROUND

Known systems and methods for detecting and preventing a current threat scenario at a location employ a physical guard at the location or sensors monitored by operators at a central monitoring service. However, such systems and methods can have high costs associated therewith. Furthermore, the central monitoring service can require low quality surveillance systems to account for a transmission distance, which can result in inaccurate monitoring, loss of property, and increased injury to people at the location.

In view of the above, there is a continuing, ongoing need for improved systems and methods.

### BRIEF DESCRIPTION OF THE DRAWINGS

FIG. 1 is a block diagram of a system in accordance with disclosed embodiments;

FIG. 2 is a block diagram of a system in accordance with disclosed embodiments;

FIG. 3 is a block diagram of a system in accordance with disclosed embodiments;

FIG. 4 is a block diagram of an artificial intelligence model in accordance with disclosed embodiments;

FIG. 5 is a block diagram of an artificial intelligence model in accordance with disclosed embodiments;

FIG. 6 is a flow diagram of a method in accordance with disclosed embodiments;

FIG. 7 is a block diagram of an artificial intelligence training model in accordance with disclosed embodiments; and

FIG. 8 is a flow diagram of a method in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein may include systems and methods for using artificial intelligence models to identify a current threat scenario. For example, systems and methods disclosed herein can train the artificial intelligence models to infer or recognize different threat scenarios using values from a plurality of sensors, including historical data from the plurality of sensors during known threat scenarios. In this regard, the artificial intelligence models can analyze the historical data to identify patterns and other features of the values from the plurality of sensors that are indicative of the known threat scenarios. The artificial intelligence models disclosed herein can include, but are not limited to recurrent neural networks and deep neural networks.

In some embodiments, the plurality of sensors can include one or multiple types of sensors, and in some embodiments, the plurality of sensors can include passive infrared sensors, audio sensors, accelerometers, gyro meters, electromagnetic interference sensors, magnetometers, illumination sensors, temperature sensors, cameras, and the like. In some embodiments, the plurality of sensors can be physically integrated together with a processor and/or the artificial intelligence models to form a single synthetic sensor.

In some embodiments, the artificial intelligence models can include a single consolidated artificial intelligence model for all of the plurality of sensors. Additionally or alternatively, in some embodiments, the artificial intelligence models can include each of a plurality of artificial intelligence models being assigned to respective ones of the plurality of sensors. Additionally or alternatively, in some embodiments, the artificial intelligence models can include each of the plurality of artificial intelligence models being assigned to a respective group of one or more of the plurality of sensors such that the plurality of artificial intelligence models can include groups directed to every possible combination of the plurality of sensors.

In some embodiments, the processor can use an output from the single consolidated artificial intelligence model to identify a current one of the different threat scenarios present in an area monitored by the plurality of sensors and execute an action corresponding to the current one of the different threat scenarios identified. Additionally or alternatively, in some embodiments, the processor can aggregate the plurality of artificial intelligence models in different ways in response to the values from the plurality of sensors, thereby providing robust protection. For example, the processor can use current ones of the values from the plurality of sensors to aggregate a respective output from each one of all or a set of the plurality of artificial intelligence models to identify the current one of the different threat scenarios and execute the action corresponding to the current one of the different threat scenarios. In some embodiments, the processor can identify the current one of the different threat scenarios based on identification thereof by multiple ones, such as a predetermined number, or all of the set of the plurality of artificial intelligence models.

The different threat scenarios can include low risk behavior, medium risk behavior, and high risk behavior. When the current one of the different threat scenarios includes the high risk behavior, such as a threat to equipment, the action corresponding to the current one of the different threat scenarios can include notifying authorities. For example, the artificial intelligence models can recognize the values from the plurality of sensors being indicative of the equipment about to catch fire or a presence of people wearing masks and carrying weapons and, responsive thereto, can notify the authorities. When the current one of the different threat scenarios incudes the medium risk behavior, the action corresponding to the current one of the different scenarios can include announcing a message in the area monitored by the plurality of sensors. For example, the artificial intelligence models can recognize the values from the plurality of sensors being indicative of multiple people present in a confined space that is contrary to established limits and, responsive thereto, broadcast the message within the confined space warning that the amount of people present exceeds the established limit.

In some embodiments, the processor can determine that one of the plurality of sensors is inoperable, such as when the one of the plurality of sensors has ceased transmitting data due to a malfunction or sabotage. Responsive thereto, the processor can account for such an inoperable sensor by selecting the set of the plurality of artificial intelligence models to omit any of the artificial intelligence models assigned to the inoperable sensor or assigned to the respective group of the plurality of sensors that includes the inoperable sensor. Additionally or alternatively, the processor can account for the inoperable sensor by aggregating the respective output from each one of all or the set of the plurality of artificial intelligence models by giving a lowest relative weight to the respective output from any of the artificial intelligence models assigned to the inoperable sensor or assigned to the respective group of the plurality of sensors includes the inoperable sensor.

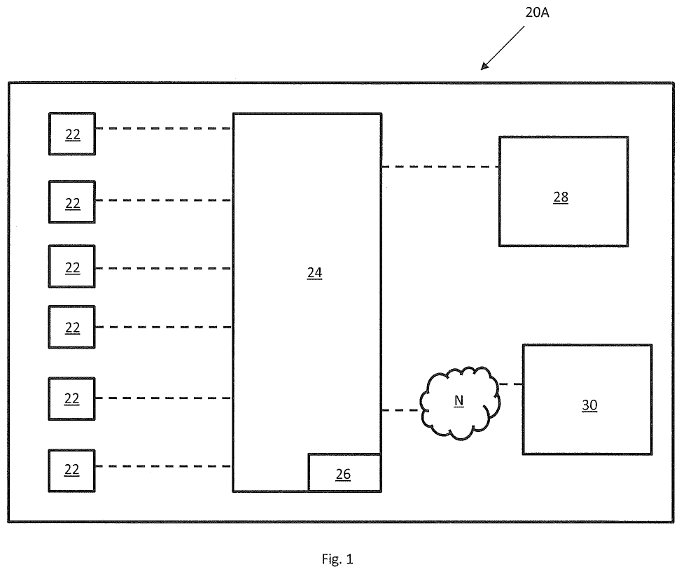

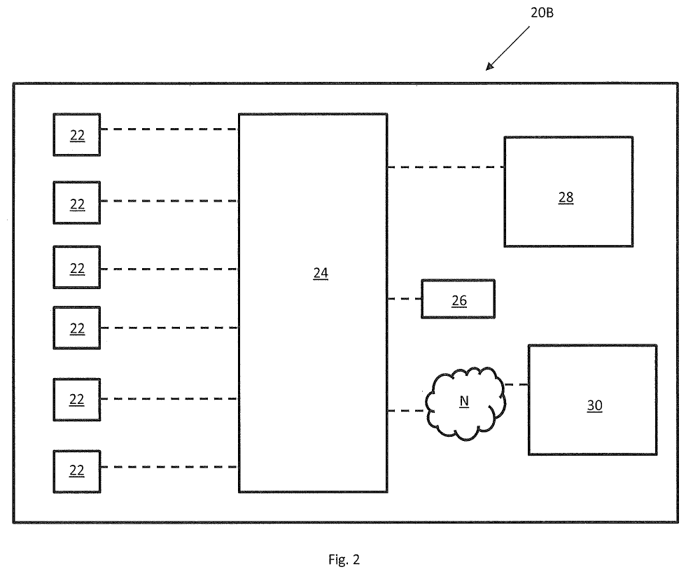

FIG. 1 is a block diagram of a system 20A in accordance with disclosed embodiments. The system 20A can include a plurality of sensors 22, a processor or controller 24, an artificial intelligence module 26 that can include a database of artificial intelligence models, a local notification system 28, and a remote system 30. As seen in FIG. 1, the artificial intelligence module 26 can be integrated with and part of the processor or controller 24, and in these embodiments, the artificial intelligence module 26, in conjunction with the processor or controller 24, may execute the artificial intelligence models with data received from the plurality of sensors. As further seen in FIG. 1, the plurality of sensors 22 can be directly coupled to the processor or controller 24 via a wireless or wired medium, the local notification system 28 can be coupled to the processor or controller 24 via a wired or wireless medium, and the remote system 30 can be coupled to the processor or controller 24 via a network N. In some embodiments, the local notification system 28 can include a speaker configured to broadcast messages from the processor or controller 24 into an area monitored by the plurality of sensors 22. In some embodiments, the remote system 30 can include a central monitoring station or a dedicated system for local law enforcement authorities. In some embodiments, the network N can include a wide area network, such as the internet, a cellular network, a phone network, and the like. FIG. 2 is a block diagram of a system 20B in accordance with disclosed embodiments. The system 20B is similar to the system 20A except that the artificial intelligence module 26 is separate from and coupled to the processor or controller 24 via a wired or wireless medium. In these embodiments, the artificial intelligence module 26 may include an integrated processor to execute the artificial intelligence models with the data from the plurality of sensors 22 received from the processor or controller 24 or to transmit the artificial intelligence models to the processor or controller 24 for execution thereby.

FIG. 3 is a block diagram of a system 20C in accordance with disclosed embodiments. The system 20C is similar to the systems 20A and 20B except that the artificial intelligence module 26 is separate from and coupled to and between both the plurality of sensors 22 and the processor or controller 24 via wired or wireless mediums. In these embodiments, the artificial intelligence module 26 may include an integrated processor to execute the artificial intelligence models with the data from the plurality of sensors 22 received directly from the plurality of sensors 22 or to transmit the artificial intelligence models and the data from the plurality of sensors 22 to the processor or controller 24 for execution thereby.

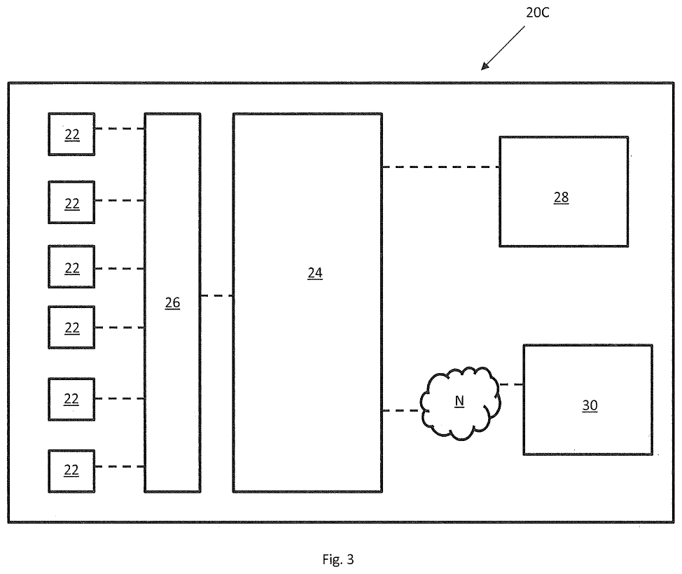

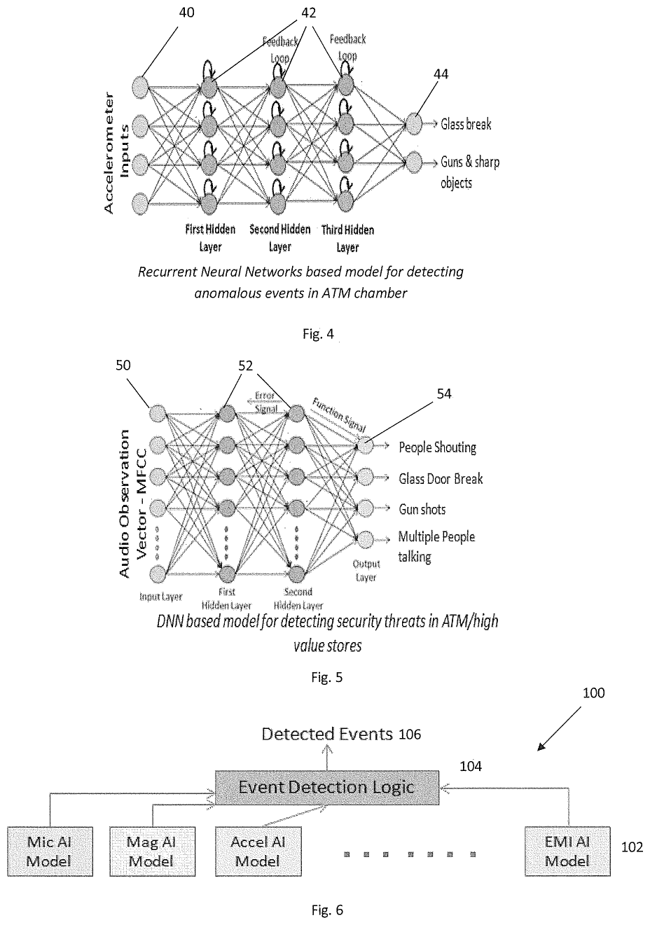

FIG. 4 is a block diagram of a recurrent neural network one of the artificial intelligence models for an accelerometer type sensor in accordance with disclosed embodiments. The artificial intelligence model for the accelerometer type sensor can include multiple input nodes 40 from one or more accelerometers, multiple hidden layer nodes 42, and output nodes 44. The multiple hidden layer nodes 42 can receive signals from the input nodes 40 and process the signals using feedback loops, node interconnections, and other similar techniques to identify the occurrence of an event at the output nodes 44. As shown in FIG. 4, in some embodiments, the event can include glass breaking or a presence of guns or sharp objects. The multiple hidden layer nodes 42 can enable the neural network to learn more complex tasks by extracting progressively more meaningful features from the input signal from the input nodes 40. Each hidden node can compute the output of the node as a non-linear function of the inputs & associated synaptic weights. The interconnected lines between multiple input nodes 40, the multiple hidden layer nodes 42, and the output nodes 44 can represent the synaptic weights, which represent the knowledge acquired by the network through the environment. As seen in FIG. 4, in some embodiments, the recurrent neural network can include feedback loops used to remember the states of the network, which helps the recurrent networks to model sequences.

FIG. 5 is a block diagram of a deep neural network one of the artificial intelligence models for an audio type sensor vector in accordance with disclosed embodiments. The artificial intelligence model for the audio type sensor vector can include multiple input nodes 50 from one or more audio type device, multiple hidden layer nodes 52, and output nodes 54. The multiple hidden layer nodes 52 can receive signals from the input nodes 50 and process the signals using node interconnections, error signals, function signals, and other similar techniques to identify the occurrence of an event at the output nodes 54. As shown in FIG. 5, in some embodiments, the event can include people shouting, a glass door breaking, gun shots, or multiple people talking. The multiple hidden layer nodes 52 can enable the neural network to learn more complex tasks by extracting progressively more meaningful features from the input signal from the input nodes 50. Each hidden node can compute the output of the node as a non-linear function of the inputs & associated synaptic weights. The interconnected lines between multiple input nodes 50, the multiple hidden layer nodes 52, and the output nodes 54 can represent the synaptic weights, which represent the knowledge acquired by the network through the environment. As seen in FIG. 5, in some embodiments, the neural network can include error signals to indicate the error between the actual output of the network and a desired output. The neural network can adjust the synaptic weights of the network so that the actual output of the network moves closer to the desired output.

FIG. 6 is a flow diagram of a method 100 in accordance with disclosed embodiments. As seen in FIG. 6, the artificial intelligence models in the database of the artificial intelligence module 26 and assigned to respective ones of the plurality of sensors 22 can receive the data from the respective ones of the plurality of sensors 22 and, responsive thereto, identify a respective one of different threat scenarios associated therewith, as in 102. Then, the processor or controller 24 can aggregate the respective one of the different threat scenarios identified by each of the artificial intelligence models, as in 104, to identify a current one of the different threat scenarios present in the area monitored by the plurality of sensors 22, as in 106.

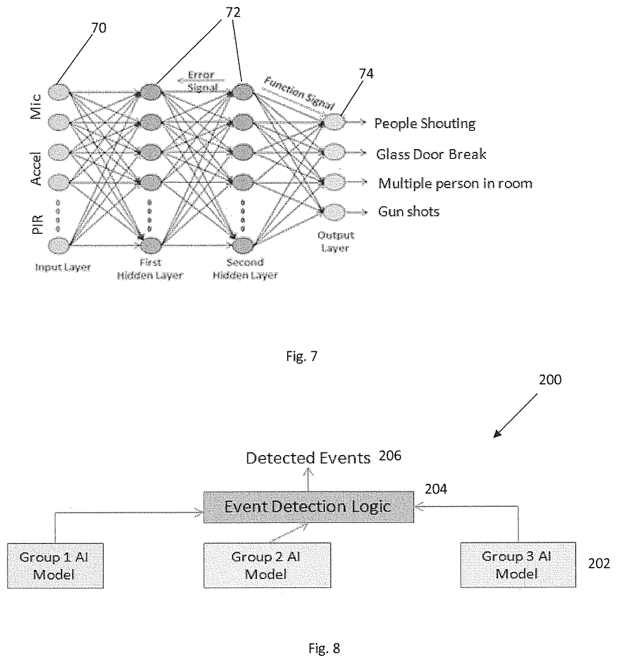

FIG. 7 is a block diagram of a group based one of the artificial intelligence models in accordance with disclosed embodiments. The group based artificial intelligence model can include multiple input nodes 70 from multiple devices of different types, multiple hidden layer nodes 72, and output nodes 74. The multiple hidden layer nodes 72 can receive signals from the input nodes 70 and process the signals using, node interconnections, error signals, function signals, and other similar techniques to identify the occurrence of an event at the output nodes 74. As shown in FIG. 7, in some embodiments, the event can include people shouting, a glass door breaking, gun shots, or multiple people talking. The multiple hidden layer nodes 72 can enable the neural network to learn more complex tasks by extracting progressively more meaningful features from the input signal from the input nodes 70. Each hidden node can compute the output of the node as a non-linear function of the inputs & associated synaptic weights. The interconnected lines between multiple input nodes 70, the multiple hidden layer nodes 72, and the output nodes 74 can represent the synaptic weights, which represent the knowledge acquired by the network through the environment. As seen in FIG. 7, in some embodiments, the neural network can include error signals to indicate the error between the actual output of the network and a desired output. The neural network can adjust the synaptic weights of the network so that the actual output of the network moves closer to the desired output. Fusing multiple sensor inputs of different types together as shown in FIG. 7 can enhance accuracy of the artificial intelligence model.

FIG. 8 is a flow diagram of a method 200 in accordance with disclosed embodiments. As seen in FIG. 8, the artificial intelligence models in the database of the artificial intelligence module 26 and assigned to a respective group of the plurality of sensors 22 can receive the data from the respective group of the plurality of sensors 22 and, responsive thereto, identify the respective one of the different threat scenarios associated therewith, as in 202. Then, the processor or controller 24 can aggregate the respective one of the different threat scenarios identified by each of the artificial intelligence models, as in 204 to identify the current one of the different threat scenarios present in the area monitored by the plurality of sensors 22, as in 206.

It is to be understood that each of the plurality of sensors 22, the processor or controller 24, the artificial intelligence module 26, the local notification system 28, and the remote system 30 disclosed herein can include a respective transceiver device and a respective memory device, each of which can be in communication with respective control circuitry, one or more respective programmable processors, and respective executable control software as would be understood by one of ordinary skill in the art. In some embodiments, the respective executable control software can be stored on a transitory or non-transitory computer readable medium, including, but not limited to local computer memory, RAM, optical storage media, magnetic storage media, flash memory, and the like, and some or all of the respective control circuitry, the respective programmable processors, and the respective executable control software can execute and control at least some of the methods described herein.

Although a few embodiments have been described in detail above, other modifications are possible. For example, the steps described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A system comprising:
a database device of an artificial intelligence module that includes a plurality of artificial intelligence models trained to recognize different threat scenarios using values from a plurality of sensors; and
a processor that uses current ones of the values from the plurality of sensors to aggregate a respective output from each one of a set of the plurality of artificial intelligence models to identify a current one of the different threat scenarios present in an area monitored by the plurality of sensors and execute an action corresponding to the current one of the different threat scenarios.

2. The system of claim 1 wherein each of the plurality of artificial intelligence models is assigned to respective ones of the plurality of sensors, and wherein each of the plurality of artificial intelligence models is trained to recognize the different threat scenarios using the values from the respective one of the plurality of sensors assigned thereto.

3. The system of claim 2 wherein the processor determines that a first of the plurality of sensors is inoperable, and wherein the processor selects the set of the plurality of artificial intelligence models to omit any of the plurality of artificial intelligence models assigned to the first of the plurality of sensors.

4. The system of claim 2 wherein the processor determines that a first of the plurality of sensors is inoperable, and wherein the processor aggregates the respective output from each one of the set of the plurality of artificial intelligence models by giving a lowest relative weight to the respective output from any of the plurality of artificial intelligence models assigned to the first of the plurality of sensors.

5. The system of claim 1 wherein each of the plurality of artificial intelligence models is assigned to a respective group of one or more of the plurality of sensors, and wherein each of the plurality of artificial intelligence models is trained to recognize the different threat scenarios using the values from the respective group of one or more of the plurality of sensors assigned thereto.

6. The system of claim 5 wherein the plurality of artificial intelligence models includes groups directed to every combination of the plurality of sensors.

7. The system of claim 5 wherein the processor determines that a first of the plurality of sensors is inoperable, and wherein the processor selects the set of the plurality of artificial intelligence models to omit any of the plurality of artificial intelligence models assigned to the first of the plurality of sensors.

8. The system of claim 5 wherein the processor determines that a first of the plurality of sensors is inoperable, and wherein the processor aggregates the respective output from each one of the set of the plurality of artificial intelligence models by giving a lowest relative weight to the respective output from any of the plurality of artificial intelligence models assigned to the first of the plurality of sensors.

9. The system of claim 1 wherein a predetermined number of the set of the plurality of artificial intelligence models identify the current one of the different threat scenarios.

10. The system of claim 1 wherein, when the current one of the different threat scenarios is indicative of a high risk behavior, the action includes notifying authorities, and wherein, when the current one of the different threat scenarios is indicative of a medium risk behavior, the action includes announcing a message in the area.

11. A method comprising:
storing a plurality of artificial intelligence models trained to recognize different threat scenarios using values from a plurality of sensors in a database device of an artificial intelligence module;
a processor using current ones of the values from the plurality of sensors to aggregate a respective output from each one of a set of the plurality of artificial intelligence models to identify a current one of the different threat scenarios present in an area monitored by the plurality of sensors; and
the processor executing an action corresponding to the current one of the different threat scenarios.

12. The method of claim 11 further comprising:
assigning each of the plurality of artificial intelligence models to respective ones of the plurality of sensors; and
training each of the plurality of artificial intelligence models to recognize the different threat scenarios using the values from the respective one of the plurality of sensors assigned thereto.

13. The method of claim 12 further comprising:
the processor determining that a first of the plurality of sensors is inoperable; and
the processor selecting the set of the plurality of artificial intelligence models to omit any of the plurality of artificial intelligence models assigned to the first of the plurality of sensors.

14. The method of claim 12 further comprising:
the processor determining that a first of the plurality of sensors is inoperable; and
the processor aggregating the respective output from each one of the set of the plurality of artificial intelligence models by giving a lowest relative weight to the respective output from any of the plurality of artificial intelligence models assigned to the first of the plurality of sensors.

15. The method of claim 11 further comprising:
assigning each of the plurality of artificial intelligence models to a respective group of one or more of the plurality of sensors; and
training each of the plurality of artificial intelligence models to recognize the different threat scenarios using the values from the respective group of the one or more of the plurality of sensors assigned thereto.

16. The method of claim 15 wherein the plurality of artificial intelligence models includes groups directed to every combination of the plurality of sensors.

17. The method of claim 15 further comprising:
the processor determining that a first of the plurality of sensors is inoperable; and
the processor selecting the set of the plurality of artificial intelligence models to omit any of the plurality of artificial intelligence models assigned to the first of the plurality of sensors.

18. The method of claim 15 further comprising:
the processor determining that a first of the plurality of sensors is inoperable; and
the processor aggregating the respective output from each one of the set of the plurality of artificial intelligence models by giving a lowest relative weight to the respective output from any of the plurality of artificial intelligence models assigned to the first of the plurality of sensors.

19. The method of claim 11 further comprising the processor identifying the current one of the different threat scenarios as one of the different threat scenarios recognized by a predetermined number of the set of the plurality of artificial intelligence models.

20. The method of claim 11 wherein, when the current one of the different threat scenarios is indicative of a high risk behavior, the action includes notifying authorities, and wherein, when the current one of the different threat scenarios is indicative of a medium risk behavior, the action includes announcing a message in the area.
